(19) United States
(12) Patent Application Publication
(10) Pub. No.: US 2012/0041993 A1
(43) Pub. Date: Feb. 16, 2012

(54) METHOD AND APPARATUS FOR CONFIGURING FUNCTIONALITY OF A CALCULATOR

(75) Inventor: Todd Michael Wostrel, Cross Roads, TX (US)

(73) Assignee: TEXAS INSTRUMENTS INCORPORATED, Dallas, TX (US)

(21) Appl. No.: 13/210,796

(22) Filed: Aug. 16, 2011

Related U.S. Application Data
(60) Provisional application No. 61/374,120, filed on Aug. 16, 2010.

(51) Int. Cl. G06F 1/24

(52) U.S. Cl. 708/130; 713/100

(57) ABSTRACT

A method and apparatus for configuring calculator functionalities available to an end user. The method includes selecting at least one of functionality to be enabled and disabled in the calculator to the end user, saving the selection in a content document, construction a new application based on the content document, and configuring the calculator according to the new application.

### CROSS-REFERENCE TO RELATED APPLICATIONS

This application claims benefit of U.S. provisional patent application Ser. No. 61/374,120, filed Aug. 16, 2010, which is herein incorporated by reference.

### BACKGROUND OF THE INVENTION

1. Field of the Invention

Embodiments of the present invention generally relate to a method and apparatus for configuring functionality of a calculator.

2. Description of the Related Art

Calculators are useful in exams. However, some functionality can be used to facilitate accessing information that should not be available to an exam taker. Most calculators do not have the ability of restricting accessing such information. Calculators that have the ability of limiting such access are not configurable.

Thus, there is a need for a calculator that is configurable on a case by case bases.

### SUMMARY OF THE INVENTION

Embodiments of the present invention relate to a method and apparatus for configuring calculator functionalities available to an end user. The method includes selecting at least one of functionality to be enabled and disabled in the calculator to the end user, saving the selection in a content document, construction a new application based on the content document, and configuring the calculator according to the new application.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment of a flow diagram for a method for configuring functionality of a calculator;

FIG. 2 is an embodiment of a content document control-based template of a calculator;

FIG. 3 is an embodiment of a content document control-based template with disabled information relating to a calculator;

FIG. 4 is an embodiment of a content document control-based template generated application 1 of a calculator;

FIG. 5 is an embodiment of a content document control-based template application 2 of a calculator; and

FIG. 6 is an embodiment of a content document control-based template configured calculator application.

### DETAILED DESCRIPTION

A general purpose application configuration solution is utilized to enable and disable functionality on a calculator. The configuration solution facilitates simple and fast configuration of calculator functionalities. For example, such solution allows non-technical users the ability to easily change the functionality delivered to end users without requiring a software change. Utilizing such a solution facilitates enforcing test restrictions, providing support for easily developing and configuring product lines from a base product to address a particular market, and to providing limited sets of functionality such as a document reader.

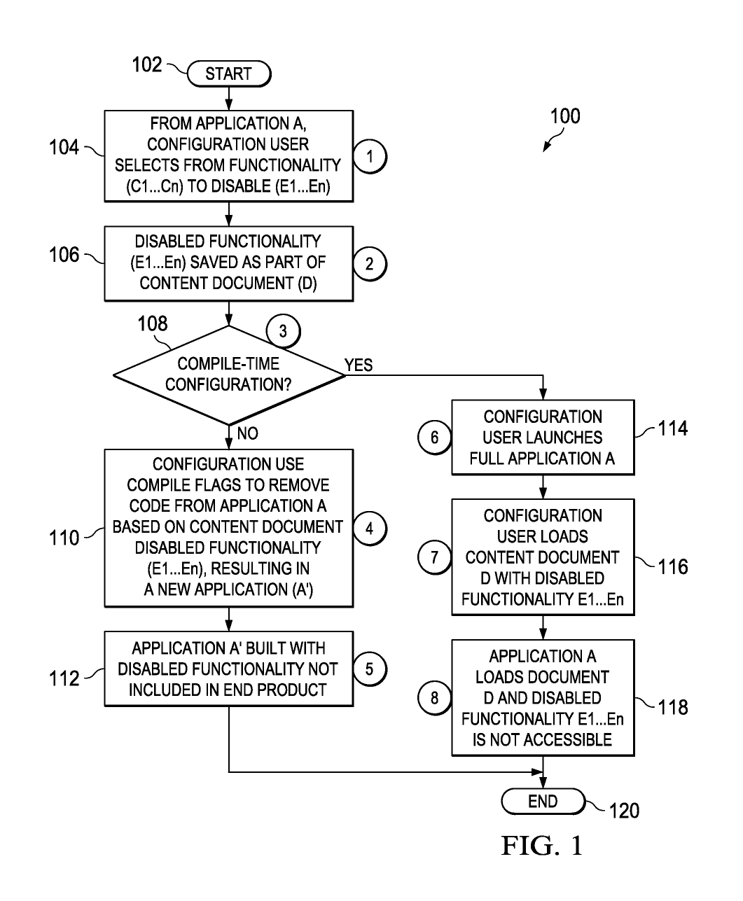

FIG. 1 is an embodiment of a flow diagram for a method 100 for configuring functionality of a calculator. The method 100 starts at step 102. At step 104, the method 100 configuration user selects enabled and disabled functionality of the calculator. At step 106, the method 100 saves disabled functionality as part of a content document.

At step 108, the method 100 determines if it is configuration compile-time. If it is not compile-time, the method 100 proceeds to step 110. At step 110, configuration user selects functionalities to be enabled and/or disabled from the original application based on the content document; accordingly, a new application is generated with the new configuration. From step 110, the method 100 proceeds to step 112. At step 112, the method 100 utilizes the new application with the disabled functionality to configure the calculator.

If it is compile time, the method 100 proceeds to step 114, wherein the configuration user launches all applications. From step 114, the method 100 proceeds to step 116. At step 116, the method 100 utilizes the content document to enable and disable functionality. At step 118, the method 100 loads the content document and disables and/or enables functionality available for an end user using the calculator. The method 100 ends at step 120

In one embodiment, the configuration is pre-determined by the configuration user and transparent to the end user. The configuration user may set the enable and disabled functionality utilizing special software, a password protected setting, a publisher version of the calculator software and the likes.

For example, if application A contains set of base functionality B and set of configurable functionalities, such as, functionalities C1 through Cn. A configuration user, such as, a teacher or school's exam proctor, selectively may enable and disable functions from C1-Cn, wherein the enable state associated with C1-Cn is represented by E1 through En. The configuration user may save functionality selection in a content document D, which includes E1 through En.

In one embodiment, the D content document is utilized during application build time, which builds application A′ based on application A with the described E1 through En. In another embodiment, at run time, the configuration user loads the D content document from application A. Both, the standard content from D content document and the functionality described by E1 through En are disabled and/or enabled. All of which may not visible or may not controllable by the end use, such as, a student.

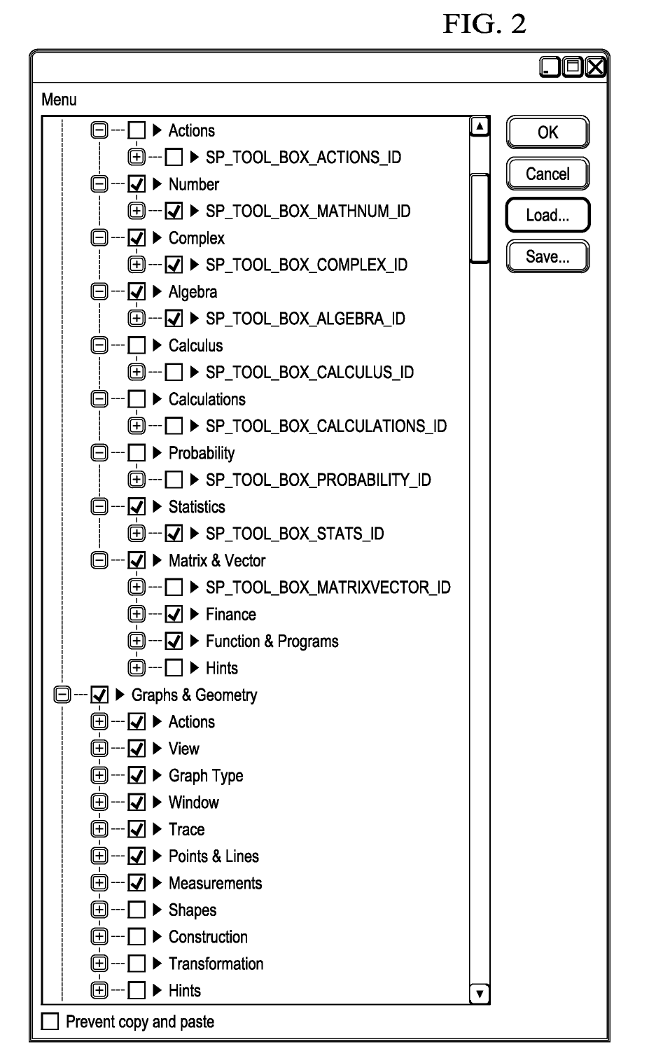

FIG. 2 is an embodiment of a content document control-based template. The configuration user configures a set of functionality to be disables and/or enabled from application A. In FIG. 2, the selection is done by checking items selected for disabling.

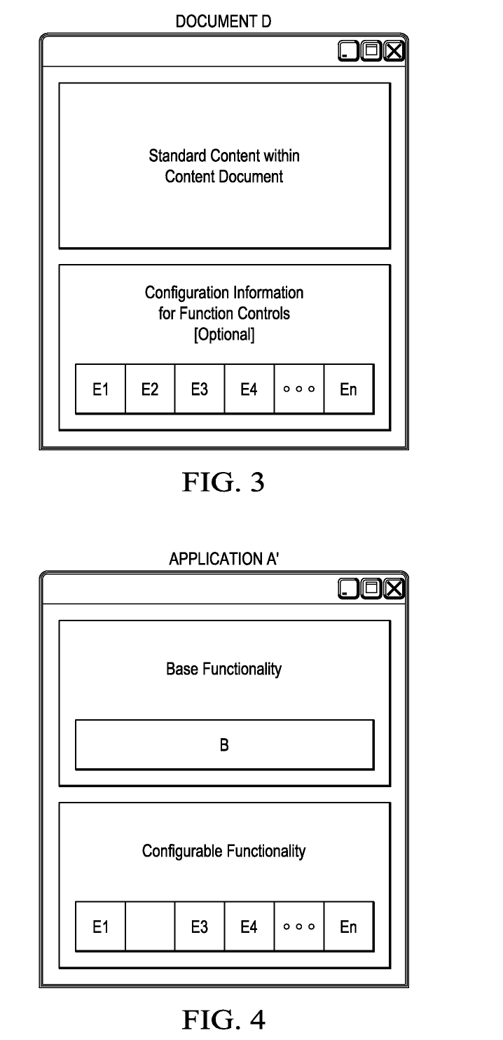

FIG. 3 is an embodiment of a content document control-based template with disabled information. The configuration user saves the document D as a standard application document, which may contain information describing the functionality to be disabled and/or enabled. FIG. 4 is an embodiment of a content document control-based template generated application 1. The application A is built using compile flags combined with configuration information contained in the content document resulting in a new application A′. Such information may be used to remove code from the end application.

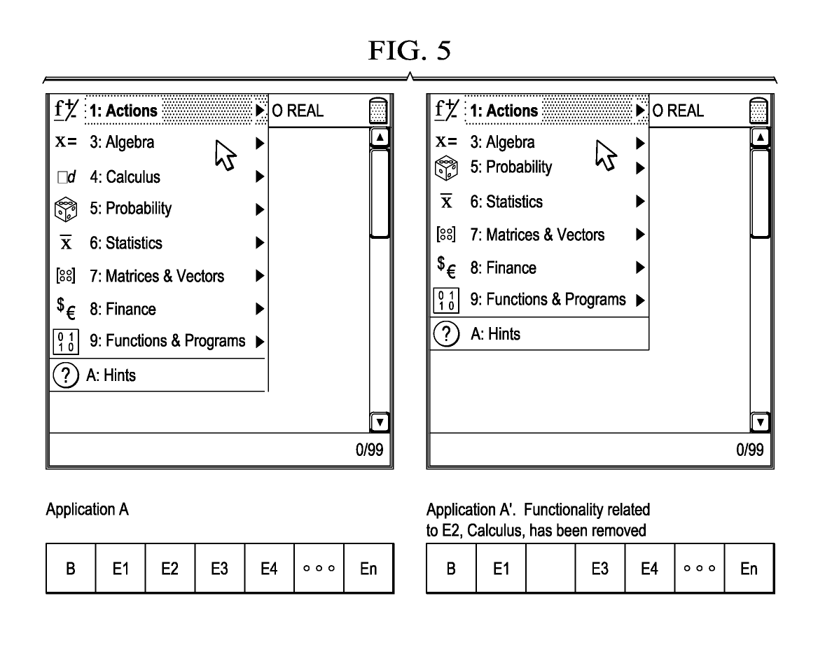

FIG. 5 is an embodiment of a content document control-based template application 2. As shown in FIG. 5, the Application A includes E2, representing calculus in this example. Whereas, Application A′ does not include E2. As such, Application A′ disables calculus from the functionalities available to the end use and, thus, calculus is removed from the drop down list.

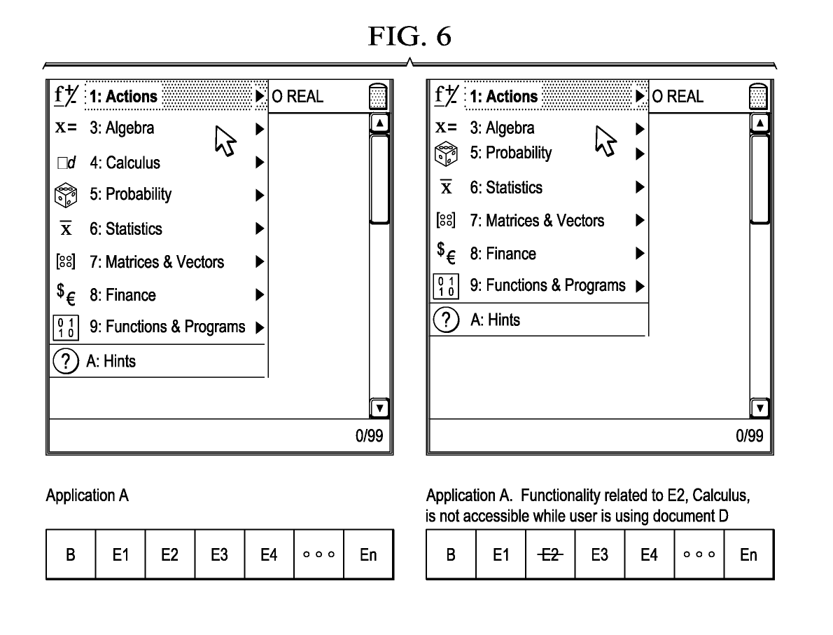

FIG. 6 is an embodiment of a content document control-based template configured calculator application. An end user utilizing a calculator with application A has calculus functionalities. An end user using a calculator with application A′ does not have calculus functionality.

While the foregoing is directed to embodiments of the present invention, other and further embodiments of the invention may be devised without departing from the basic scope thereof, and the scope thereof is determined by the claims that follow.

What is claimed is:

1. A method for configuring calculator functionalities available to an end user, comprising:
selecting at least one of functionality to be enabled and disabled in the calculator to the end user;
saving the selection in a content document;
construction a new application based on the content document; and
configuring the calculator according to the new application.

2. The method of claim 1 wherein the configuring of the calculator according to the new application is done at at least one of build time and at run time.

3. A calculator with configurable functionality available to an end user, comprising:
means for selecting at least one of functionality to be enabled and disabled in the calculator to the end user;
means for saving the selection in a content document;
means for construction a new application based on the content document; and
means for configuring the calculator according to the new application.

4. The calculator of claim 3 wherein the configuring of the calculator according to the new application is done at at least one of build time and at run time.

5. A non-transitory computer readable medium with computer instruction when executed perform a method for configuring calculator functionality, the method comprising:
selecting at least one of functionality to be enabled and disabled in the calculator to the end user;
saving the selection in a content document;
construction a new application based on the content document; and
configuring the calculator according to the new application.

6. The non-transitory computer readable medium of claim 5 wherein the configuring of the calculator according to the new application is done at at least one of build time and at run time.
